(19) United States
(12) Patent Application Publication
(10) Pub. No.: US 2019/0217769 A1
(43) Pub. Date: Jul. 18, 2019

(54) Rear Light Safety System

(71) Applicant: Kenneth Alan Nekic, Columbus, OH (US)

(72) Inventor: Kenneth Alan Nekic, Columbus, OH (US)

(21) Appl. No.: 16/251,800

(22) Filed: Jan. 18, 2019

Related U.S. Application Data
(60) Provisional application No. 62/619,057, filed on Jan. 18, 2018.
(60) Provisional application No. 62/619,074, filed on Jan. 18, 2018.

(51) Int. Cl. B60Q 1/30; B60Q 1/44; B60Q 1/52

(52) U.S. Cl. CPC B60Q 1/302; B60Q 1/52; B60Q 1/448

(57) ABSTRACT

Disclosed herein are safety lighting systems comprising a plurality of lights configured for selective illumination in response to various signals and conditions of a vehicle.

### CROSS-REFERENCE TO RELATED APPLICATION(S)

This application claims priority to U.S. Provisional Patent Application No. 62/619,057, filed Jan. 18, 2018, and U.S. Provisional Patent Application No. 62/619,074, filed Jan. 18, 2018, the contents of each of which are hereby incorporate by reference in their entireties.

### TECHNICAL FIELD

Described herein are safety lighting systems for vehicles. More particularly, the safety lighting system is linked to the rate of deceleration of the vehicle and clearly indicates when the vehicle is stopping and/or braking (including a rapid stopping or hard braking condition), in reverse, or completely stopped, thereby increasing safety for the vehicle and surrounding motorists, riders, or pedestrians.

### BACKGROUND

The information included in this Background section of the specification, including any references cited herein and any description or discussion thereof, is included for technical reference purposes only and is not to be regarded subject matter by which the scope of the invention as defined in the claims is to be bound.

Historically, vehicles have been provided with brake lights that operate in a purely binary (one-dimensional) sense (i.e., either illuminated or not). This binary (one-dimensional) system only indicates to other motorists, riders, or pedestrians whether the vehicle user is activating or not activating the brakes, but have no indication of the braking condition (i.e., mere slowing down using the brakes, coming to a complete stop, or riding the brakes). Moreover, the other motorists, riders, or pedestrians have no indication that a car is at a complete stop when the brakes have not been activated (e.g., after a collision in which the brakes were not applied or have been released). Without the ability to correlate the visual brake signal with the braking conditions, the other motorists, riders, or pedestrians have no way to critically assess the visual brake light information, which is undesirable and may lead to an increase in the number of collisions and the decrease in safety for all motorists and riders. For example, a motorist, rider, or pedestrian traveling near or behind another motorist, rider, or pedestrian may interpret visual brake light information as stopping when, in reality, the other motorist, rider, or pedestrian may simply be slowing down. Conversely, a motorist, rider, or pedestrian traveling near or behind another motorist, rider, or pedestrian may interpret visual brake light information as slowing down when, in reality, the other motorist, rider, or pedestrian may have come to a complete stop. In this way, with current systems, there is no way to differentiate between “normal” and emergency or panic braking conditions.

Because standard, binary (one-dimensional) brake lights do not provide any visual indications other than that the brakes have been activated, misinterpretations of the precise braking conditions are common and dangerous. As a result, a need exists for an effective system for indicating to (e.g., warning) other motorists, riders, or pedestrians of the braking conditions of other motorists and riders.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments of the invention and illustrated in the accompanying drawings.

The present disclosure is generally related to a safety lighting system adapted for attachment to or integration with a vehicle (e.g., car, truck, motorcycle, bicycle) to increase safety for the driver of the vehicle and surrounding motorists, riders, or pedestrians. In particular, the safety lighting system of the present disclosure provides an arrangement of lights (e.g., light emitting diodes) that are configured for illumination in a pre-determined sequence in response to the activation of the brakes of the vehicle and, more specifically, proportional to a rate of deceleration of the associated vehicle (as opposed to prior approaches relying on the travel of the brake pedal and/or the amount of pressure applied to the brake pedal). The safety lighting system is envisaged for the aftermarket or retrofit market to existing vehicles, though it is also contemplated that future vehicles could be integrally formed with a safety lighting system of the present disclosure. In this regard, the safety lighting system of the present disclosure may be used in combination with, or, alternatively, as a substitute for, the conventional brake lights of a vehicle.

A safety lighting system embodying the present disclosure may include a controller, a central portion, and first and second side portions, each of the portions including its own light emitting diodes. The controller may be configured to receive at least one of speed and acceleration information of an associated vehicle including brakes. The central portion may include a first plurality of light emitting diodes. The first plurality of light emitting diodes may be configured for illumination in response to activation of the brakes of the associated vehicle. The first and second side portions may be positioned on opposite sides of the central portion. Each of the first and second side portions may include a second plurality of light emitting diodes configured for sequential illumination. The second plurality of light emitting diodes may be configured for sequential illumination from a proximate end to a distal end of a corresponding one of the first and second side portions. The second plurality of light emitting diodes may be configured for sequential illumination in response to and proportional to a rate of deceleration of the associated vehicle.

In particular embodiments, the second plurality of light emitting diodes may be arranged in at least five discrete sections. Each of the five discrete sections may be associated with a discrete range of the rate of deceleration of the associated vehicle. Additional ones of the discrete sections may be sequentially illuminated as the rate of deceleration of the associated vehicle increases.

Each of the first and second side portions may further include a third plurality of light emitting diodes. The third plurality of light emitting diodes may be located at the distal end of a corresponding one of the first and second side portions. The third plurality of light emitting diodes may be configured for flashing illumination in association with a turn signal of the associated vehicle.

In certain constructions, each of the first and second side portions may further include a fourth plurality of light emitting diodes. The fourth plurality of light emitting diodes may surround the first plurality of light emitting diodes. The fourth plurality of light emitting diodes may be configured for illumination in response to a signal indicating that the associated vehicle is stopped. In particular embodiments, each of the first and second side portions may further include a fifth plurality of light emitting diodes. The fifth plurality of light emitting diodes may surround the third plurality of light emitting diodes. The fifth plurality of light emitting diodes may be configured for illumination in response to a signal indicating that the associated vehicle is stopped. The first, second, and third pluralities of light emitting diodes may be configured for illumination in a first color (e.g., red). The fourth and fifth pluralities of light emitting diodes may be configured for illumination in a second color (e.g., yellow) different from the first color.

In particular embodiments, each of the first and second side portions may further include a sixth plurality of light emitting diodes. The sixth plurality of light emitting diodes may border the second plurality of light emitting diodes. The sixth plurality of light emitting diodes may be configured for illumination in association with a reverse light of the associated vehicle. The sixth plurality of light emitting diodes may be configured for illumination in a third color (e.g., white) different from the first and second colors. The sixth plurality of light emitting diodes may be configured for flashing illumination in response to a signal indicating that the associated vehicle is in motion in reverse.

In certain constructions, each of the first and second side portions may further include a seventh plurality of light emitting diodes. The seventh plurality of light emitting diodes may border the second plurality of light emitting diodes. The seventh plurality of light emitting diodes may be configured for illumination in response to activation of the brakes of the associated vehicle. The seventh plurality of light emitting diodes may be configured for flashing illumination in response to a signal indicating a rapid stopping or hard braking condition associated with rapid deceleration of the associated vehicle. The seventh plurality of light emitting diodes may be configured for illumination in the third color (e.g., white).

In particular embodiments, the safety lighting system may further include an accelerometer. The accelerometer may be configured to detect acceleration of the associated vehicle.

In certain constructions, the safety lighting system may further include an emergency light positioned above the central portion. The emergency light may be configured for illumination in response to a signal indicating an emergency condition.

In particular embodiments, each of the first, second, and third pluralities of light emitting diodes may be configured for illumination of an emergency message in response to the accelerometer detecting a rate of deceleration greater than a predetermined threshold.

In certain constructions, the safety lighting system may further include an internal battery. The internal battery may be configured to power the safety lighting system. The safety lighting system may further include at least one solar panel electrically connected to the internal battery.

In particular embodiments, the safety lighting system may further include a dongle. The dongle may be configured for electrical connection to the associated vehicle and configured to wirelessly transmit the at least one of speed and acceleration information to the safety lighting system.

A related safety lighting system embodying the present disclosure may include a controller and a plurality of light emitting diodes arranged so as to define each of a central portion, first and second side portions, and first and second end portions. The controller may be configured to receive at least one of speed and acceleration information of an associated vehicle including brakes. The first and second side portions may be positioned on opposite sides of the central portion. The first end portion may be located at a distal end of the first side portion. The second end portion may be located at a distal end of the second side portion. The plurality of light emitting diodes may be selectively illuminable in accordance with at least the following illumination states: (a) an illumination state in which the light emitting diodes arranged in the central portion and the first and second end portions are configured for illumination in response to activation of the brakes of the associated vehicle; and (b) an illumination state in which the light emitting diodes arranged in each of the first and second side portions are configured for sequential illumination from a proximate end to a distal end thereof in response to and proportional to a rate of deceleration of the associated vehicle

### BRIEF DESCRIPTION OF THE DRAWINGS

The foregoing and other features of the present disclosure will become more fully apparent from the following description, taken in conjunction with the accompanying drawings. These drawings depict only several exemplary embodiments in accordance with the disclosure and are, therefore, not to be considered limiting its scope. The disclosure will be described with additional specificity and detail through use of the accompanying drawings.

In the drawings:

FIG. 1 is a perspective view of one embodiment of the disclosed safety lighting system in combination with a vehicle;

FIG. 2 is a front view of one embodiment of the disclosed safety lighting system;

FIG. 3 shows one embodiment of the disclosed safety lighting system in use and illustrates illumination of the safety lighting system under normal driving conditions (i.e., no slowing or braking of the vehicle);

FIG. 4 shows one embodiment of the disclosed safety lighting system in use and illustrates illumination of the safety lighting system under a turning condition (i.e., activation of the right turn signal of the vehicle) in which the border lights are constantly illuminated;

FIG. 5 shows one embodiment of the disclosed safety lighting system in use and illustrates illumination of the safety lighting system under an initial braking condition (i.e., initial activation of the brakes), causing the interior lights to be illuminated in red;

FIG. 6 shows one embodiment of the disclosed safety lighting system in use and illustrates illumination of the safety lighting system as the brakes are activated and the vehicle begins to decelerate (i.e., to a rate of deceleration of about 10%), causing a first section of the progressive lights to be illuminated in red;

FIG. 7 shows one embodiment of the disclosed safety lighting system in use and illustrates illumination of the safety lighting system as the brakes remain activated and the vehicle continues to decelerate (i.e., to a rate of deceleration of about 30%), causing a second section of the progressive lights to be illuminated in red (in addition to the first section);

FIG. 8 shows one embodiment of the disclosed safety lighting system in use and illustrates illumination of the safety lighting system as the brakes remain activated and the vehicle continues to decelerate (i.e., to a rate of deceleration of about 50%), causing a third section of the progressive lights to be illuminated in red (in addition to the first and second sections);

FIG. 9 shows one embodiment of the disclosed safety lighting system in use and illustrates illumination of the safety lighting system as the brakes remain activated and the vehicle continues to decelerate (i.e., to a rate of deceleration of about 70%), causing a fourth section of the progressive lights to be illuminated in red (in addition to the first, second, and third sections);

FIG. 10 shows one embodiment of the disclosed safety lighting system in use and illustrates illumination of the safety lighting system as the brakes remain activated and the vehicle continues to decelerate (i.e., to a rate of deceleration of about 90%), causing a fifth and final section of the progressive lights to be illuminated in red (in addition to the first, second, third, and fourth sections);

FIG. 11 shows one embodiment of the disclosed safety lighting system in use and illustrates illumination of the safety lighting system as the brakes remain activated under a completely stopped condition (i.e., zero acceleration of the vehicle), causing the surrounding lights to be illuminated in yellow (in addition to illumination of the interior lights in red); and

FIG. 12 shows one embodiment of the disclosed safety lighting system in use and illustrates illumination of the safety lighting system under a rapid slowing or hard braking condition (i.e., raid deceleration of the vehicle), causing the warning lights to be illuminated in white (in addition to illumination of the interior lights and progressive lights in red).

### DETAILED DESCRIPTION

The present disclosure may be understood more readily by reference to the following detailed description of desired embodiments and the examples included therein. In the following specification and the claims which follow, reference will be made to a number of terms which shall be defined to have the following meanings.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

The term “comprising” is used herein as requiring the presence of the named component and allowing the presence of other components. The term “comprising” should be construed to include the term “consisting of”, which allows the presence of only the named component, along with any impurities that might result from the manufacture of the named component.

Numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 inches” is inclusive of the endpoints, 2 inches and 10 inches, and all the intermediate values). The endpoints of the ranges and any values disclosed herein are not limited to the precise range or value; they are sufficiently imprecise to include values approximating these ranges and/or values.

The modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range of “from about 2 to about 10” also discloses the range “from 2 to 10.”

The terms “substantially” and “about” can be used to include any numerical value that can vary without changing the basic function of that value. When used with a range, “substantially” and “about” also disclose the range defined by the absolute values of the two endpoints, e.g. “about 2 to about 4” also discloses the range “from 2 to 4.” The terms “substantially” and “about” may refer to plus or minus 10% of the indicated number.

The present disclosure may refer to components as having a length, width, height, and thickness. It is noted that “length” and “width” are used interchangeably herein, or put another way, these terms refer to the same dimension or axis.

It should be noted that many of the terms used herein are relative terms. For example, the terms “upper” and “lower” are relative to each other in location, i.e. an upper component is located at a higher elevation than a lower component in a given orientation, but these terms can change if the device is flipped. The terms “horizontal” and “vertical” are used to indicate direction relative to an absolute reference, i.e. ground level. The terms “above” and “below”, or “upwards” and “downwards” are also relative to an absolute reference; an upwards flow is always against the gravity of the earth.

The term “parallel” should be construed in its lay term as two edges or faces generally continuously having the same distance between them, and should not be strictly construed in mathematical terms as requiring that the two edges or faces cannot intersect when extended for an infinite distance. Similarly, the term “planar” should not be strictly construed as requiring that a given surface be perfectly flat.

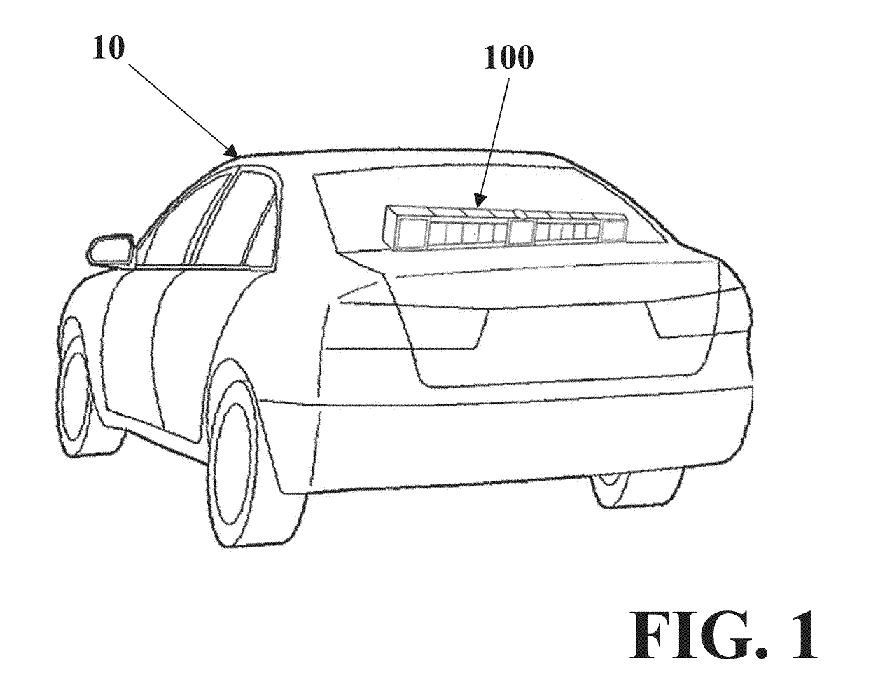

With reference now to FIG. 1, a safety lighting system 100 according to the present disclosure is depicted in combination with a vehicle 10. In particular, the safety lighting system 100 is mounted at the rear of the vehicle 10, such that the safety lighting system 100 is clearly visible to other motorists, riders, or pedestrians in the vicinity of the vehicle 10. In this purely exemplary depiction, the safety lighting system 100 is shown in the rear window of the vehicle 10, though it is to be understood that the safety lighting system 100 can be located anywhere on or in the vehicle that renders the safety lighting system 100 clearly visible to other motorists, riders, or pedestrians. As a non-limiting example, it is specifically contemplated that the safety lighting system 100 could alternatively be mounted on the rear bumper or trunk of the vehicle, generally between the stock rear brake lights. As another non-limiting example, it is contemplated that the safety lighting system 100 could be integrated into the vehicle. In this way, the precise location of the safety lighting system 100 may be chosen for a desired application so long as the safety lighting system 100 may be clearly visible to other motorists, riders, or pedestrians in the vicinity of the vehicle 10, which suitable locations will be readily understood by those skilled in the art.

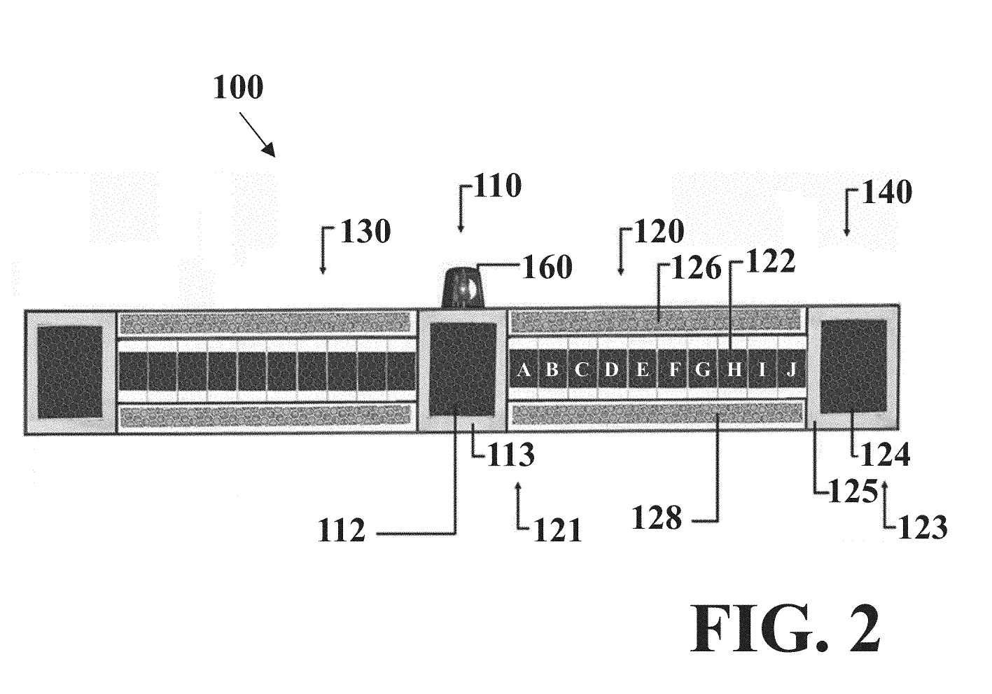

FIG. 2 shows the details of the safety lighting system 100. In the exemplary embodiment depicted in FIG. 2, the safety lighting system is generally defined by a central portion 110 and first and second side portions 120, 130 positioned on opposite sides of the central portion 110 and extending outwardly therefrom. Each of the central and first and second side portions is defined by a series of lights. The lights are preferably solid-state devices, such as light emitting diodes (LEDs), though it is to be understood that the lights could be incandescent lights, halogen lights, metal-halide lights, and the like. In the embodiment shown in FIG. 2, the lights are LEDs that cover substantially all of the front face of the safety lighting system 100. The LEDs can be provided and arranged in any suitable fashion, such as by being mounted to a substrate (e.g., a printed circuit board) and housed behind an optically transparent cover designed to protect the LEDs from dirt, debris, and moisture. Although the safety lighting system depicted in FIG. 2 is shown as a rectangular cuboid, it is to be understood that the safety lighting system could be provided in many other shapes and configurations, as will be appreciated by those skilled in the art.

The central portion 110 of the safety lighting system 100 includes a first set or arrangement of interior lights 112 (e.g., LEDs). As will be explained in greater detail herein, the interior lights 112 in the central portion 110 are configured to illuminate in response to activation of the brakes of the vehicle. That is, the interior lights 112 in the central portion 110 may function similarly to the third brake light conventionally employed on existing vehicles and illuminate in response to activation of the brakes. In this regard, the interior lights 112 in the central portion 110 can be electrically connected to an existing third brake light (or the wires running thereto), such that activation of the brakes automatically causes the interior lights 112 in the central portion 110 to illuminate. In some embodiments, the interior lights 112 in the central portion 110 may be configured to illuminate upon initial activation of the brakes, but then cease illumination once the rate of deceleration of the vehicle is greater than a predetermined threshold (e.g., once the rate of deceleration of the vehicle is greater than about 10%).

With continued reference to the central portion 110, the central portion may further include another set or arrangement of surrounding lights 113. As shown in FIG. 2, the surrounding lights 113 may surround (i.e., on all sides) the interior lights 112 in the central portion 110 of the safety lighting system. Preferably, the interior lights 112 are visually distinguishable from the surrounding lights 113. For example, the interior lights 112 of the central portion 110 may be of a first color (e.g., red), and the surrounding lights 113 may be of a second, different color (e.g., yellow). The surrounding lights 113 may be configured for illumination in response to a signal indicating that the vehicle is stopped. As will be explained in greater detail herein, the signal indicating that the vehicle is stopped may still be sent to the surrounding lights 113 with or without activation of the brakes (i.e., because illumination of the surrounding lights is triggered by the rate of deceleration of the vehicle and not dependent on activation of the brakes). This may occur, for example, where the vehicle has been in a collision, but the brakes have not been activated (i.e., the brake pedal was not pressed) or are no longer activated (i.e., the brake pedal is no longer being pressed). This provides a major advantage in terms of safety because the surrounding lights 113 can provide a visual indication that the vehicle is completely stopped, which information cannot be relayed by conventional, binary (one-dimensional) brake lights, especially in cases where the brake pedal was not pressed or is no longer being pressed. Put another way, other motorists, riders, or pedestrians in the vicinity of the vehicle will recognize that the surrounding lights 113 are illuminated and immediately understand that the vehicle is completely stopped, thereby affording valuable additional time to respond accordingly and take any corrective action as may be necessary (e.g., slowing down to avoid the stopped vehicle). The surrounding lights 113 can be configured to remain illuminated, constantly, while the vehicle is completely stopped. Alternatively, the surrounding lights 113 may be configured (e.g., through a use of a timer) to illuminate when the vehicle comes to a complete stop and then cease illumination after a predetermined period of time (e.g., three seconds), such that the surrounding lights 113 do not remain illuminated in situations such as where the car is idling or in stop-and-go traffic involving prolonged periods of no movement. In some embodiments, the interior lights 112 of the central portion 110 may be configured to remain illuminated for as long as the brakes are activated (i.e., while the brake pedal is depressed).

As is readily apparent from FIG. 2, the first and second side portions 120, 130 are generally symmetrical with respect to one another. As a result, only the features of the first side portion 120 are labeled and discussed herein, though it will be readily understood that the second side portion 130 is effectively symmetrically identical.

The first side portion 120 extends outwardly away from the central portion 110 from a proximate end 121 to a distal end 123 of the first side portion. At the distal end 123 of the first side portion 120, a set or arrangement of interior lights 124 (e.g., LEDs) are provided (i.e., in a first end portion 140). As can be seen, the interior lights 124 may be structured similarly to the interior lights 112 of the central portion 110. In particular, the number and arrangement of the interior lights 124 at the distal end 123 of the first side portion 120 may be identical to the number and arrangement of the interior lights 112 in the central portion 110. The interior lights 124 at the distal end 123 of the first side portion 120 may be configured to illuminate in a flashing pattern in association with a turn signal of the vehicle. That is, the interior lights 124 at the distal end 123 of the first side portion 120 (i.e., in the first end portion 140) may function similarly to the rear turn signal light(s) conventionally employed on existing vehicles and illuminate in response to activation of the turn signal. In particular, the interior lights 124 at the distal end 123 of the first side portion 120 may function in association with one of the turn signal lights, and the interior lights at the distal end of the second side portion 130 may function in association with the other of the turn signal lights. In this regard, the interior lights 124 at the distal end 123 of the first side portion 120 can be electrically connected to an existing turn signal light(s) (or the wires running thereto), such that activation of the turn signal automatically causes the interior lights 124 at the distal end 123 of the first side portion 120 to illuminate.

With continued reference to the distal end 123 of the first end portion 120, the first end portion may further include another set or arrangement of surrounding lights 125. As shown in FIG. 2, the surrounding lights 125 may surround (i.e., on all sides) the interior lights 124 at the distal end 123 of the first end portion 120 of the safety lighting system. Preferably, the interior lights 124 are visually distinguishable from the surrounding lights 125. For example, the interior lights 124 at the distal end 123 of the first end portion 120 may be of a first color (e.g., red), and the surrounding lights 125 may be of a second, different color (e.g., yellow).

Again, the interior lights 124 at the distal end 123 of the first end portion 120 may be the same in number, arrangement, and color as the interior lights 112 of the central portion, and the surrounding lights 125 at the distal end 123 of the first end portion 120 may similarly be the same in number, arrangement, and color as the surrounding lights 113 of the central portion. The surrounding lights 125 at the distal end 123 of the first end portion 120 may be configured for illumination in response to a signal indicating that the vehicle is stopped. As will be explained in greater detail herein, the signal indicating that the vehicle is stopped may still be sent to the surrounding lights 125 with or without activation of the brakes (i.e., because illumination of the surrounding lights is triggered by the rate of deceleration of the vehicle and not dependent on activation of the brakes). This may occur, for example, where the vehicle has been in a collision, but the brakes have not been activated (i.e., the brake pedal was not pressed) or are no longer activated (i.e., the brake pedal is no longer being pressed). This provides a major advantage in terms of safety because the surrounding lights 125 can provide a visual indication that the vehicle is completely stopped, which information cannot be relayed by conventional, binary (one-dimensional) brake lights, especially in cases where the brake pedal was not pressed or is no longer being pressed. Put another way, other motorists, riders, or pedestrians in the vicinity of the vehicle will recognize that the surrounding lights 125 are illuminated and immediately understand that the vehicle is completely stopped, thereby affording valuable additional time to respond accordingly and take any corrective action as may be necessary (e.g., slowing down to avoid the stopped vehicle). The surrounding lights 125 can be configured to remain illuminated, constantly, while the vehicle is completely stopped. Alternatively, the surrounding lights 125 may be configured (e.g., through a use of a timer) to illuminate when the vehicle comes to a complete stop and then cease illumination after a predetermined period of time, such that the surrounding lights 125 do not remain illuminated in situations such as where the car is idling or in stop-and-go traffic involving prolonged periods of no movement.

Another set or arrangement of lights 122 (e.g., LEDs) are arranged between the proximate end 121 and the distal end 123 of the first side portion 120. These lights 122 may be referred to herein as sequential or progressive lights. As can be seen in FIG. 2, the progressive lights 122 are arranged in discrete sections. In particular, in the exemplary embodiment depicted in FIG. 2, the progressive lights 122 are arranged in ten discrete sections 122A, 122B, 122C, 122D, 122E, 122F, 122G, 122H, 122I, and 122J, though it is to be understood that the progressive lights 122 may be arranged in as many or as few sections as desired and as may fit the desired application. Preferably, the progressive lights 122 are arranged in at least five discrete sections so that the sequential illuminating nature of the progressive lights 122, as will be explained in greater detail herein, will be immediately recognized and appreciated by nearby motorists, riders, or pedestrians.

The progressive lights 122 are configured for illumination in response to and proportional to a rate of deceleration of the vehicle. Put another way, upon receipt of a signal that the vehicle has begun to decelerate, the progressive lights 122 are configured to illuminate sequentially in a direction from the proximate end 121 of the first end portion 120 to the distal end 123 thereof That is, in the embodiment depicted in FIG. 2, upon receipt of a signal that the vehicle has reached a rate of deceleration over a predetermined threshold (e.g., a 10% reduction in acceleration), the section closest to the proximate end 121 of the first end portion 120, section 122A in this case, will be illuminated first. If the vehicle continues to decelerate (e.g., achieving a 20% reduction in acceleration) the next section, section 122B in this case, will illuminate. This pattern continues, sequentially from the proximal end 121 to the distal end 123 of the first end portion 120 (i.e., outwardly away from the central portion 120 toward the first end portion 140) as the vehicle continues to decelerate, such that the section closest to the distal end 123 of the first end portion 120, section 122j in this case, will be illuminated last.

The discrete sections (i.e., 122A-J) of the progressive lights 122 may, in some embodiments, correspond to a ratio or percentage of the vehicle's initial acceleration at a time immediately before deceleration begins. For example, the first section 122A may correspond to a 10% reduction in deceleration, section 122B may correspond to a 20% reduction in deceleration, section 122C may correspond to a 30% reduction in deceleration, section 122D may correspond to a 40% reduction in deceleration, section 122E may correspond to a 50% reduction in deceleration, section 122F may correspond to a 60% reduction in deceleration, section 122G may correspond to a 70% reduction in deceleration, section 122H may correspond to a 80% reduction in deceleration, section 122I may correspond to a 90% reduction in deceleration, and the last section 122J may correspond to a 95% reduction in deceleration. In this exemplary embodiment, if the vehicle was traveling at a speed of about 50 mph prior to activating the brakes, the first section 122A would illuminate when the vehicle slowed to a speed of about 45 mph, section 122B would illuminate as the vehicle slowed to a speed of about 40 mph, section 122C would illuminate as the vehicle slowed to a speed of about 35 mph, and so on and so forth.

Notably, at the time of illumination of section 122C, sections 122A and 122B would still be illuminated, such that as the vehicle's speed and/or rate of deceleration increases, the number of lights and discrete sections of progressive lights 122 increases. Although specific ratios and percentages of the vehicle's speed and/or rate of deceleration are given in the foregoing example, it is to be understood that the discrete arrangements or sections of the progressive lights 122 may correspond to any desired ratio or percentage of the vehicle's speed and/or rate of deceleration so long as progressive lights 122 are illuminated sequentially from the proximate end 121 toward the distal end 123 of the first end portion 120 (i.e., such that the number of lights and discrete sections of progressive lights 122 increases from the proximate end 121 toward the distal end 123 of the first end portion 120). Put another way, the discrete sections of the progressive lights 122 are configured so that more lights and sections are illuminated in proportion to a decrease in speed and/or acceleration as slowing and/or braking occurs. Preferably, the safety lighting system 100 is configured such that there is a very small delay in the growth or the decay of the illumination, such that the illumination of the progressive lights 122 is a smooth sequential illumination that is easily recognizable by surrounding motorists, riders, or pedestrians.

As will now be appreciated, when the vehicle reaches a complete stop (irrespective of whether the brake pedal was or is currently depressed), at least the full arrangement of progressive lights 122 will be illuminated in addition to the surrounding lights 113 of the central portion 120 and the surrounding lights 125 of end portion 140. In comparison, in conventional, binary (one-dimensional) braking systems currently in use, unless the brake pedal is depressed, no lights are illuminated. Moreover, even when the brake pedal is continuously depressed after the vehicle has come to a complete stop (e.g., from a collision), only a small number (typically two or three) lights are illuminated in a common color (typically red). With the safety lighting system 100 of the present disclosure, on the other hand, if the brake pedal is continuously depressed after the vehicle has come to a complete stop (e.g., from a collision), the interior 112 and surrounding lights 113 of the central portion and the warning lights 128 will be illuminated. The warning lights 128 will remain illuminated after the complete stopping until the vehicle begins to move again (even if pressure has been removed from the brakes). Preferably, the various lights of the safety lighting system will be illuminated in at least two different colors, thereby increasing recognition times for nearby motorists, riders, or pedestrians and increasing safety for all.

In some embodiments, a set or arrangement of lights may define a border of the safety lighting system. These border lights may be configured for constant illumination, or, alternatively, when it is dark enough out that visibility of the safety lighting system might otherwise be compromised. That is, the bordering lights may function similarly to the running lights conventionally employed on existing vehicles and illuminate in response to a decrease in ambient light below a predetermined threshold. In this regard, the surrounding lights can be electrically connected to existing running lights (or the wires running thereto), such that activation of the running lights automatically causes the border lights to illuminate.

The first and second end portions 120, 130 may each further include additional sets or arrangements of lights. For example, as depicted in FIG. 2, a set or arrangement of backing lights 126 may be provided along a border of the progressive lights 122. In the exemplary embodiment of FIG. 2, the backing lights 126 form an upper border of the arrangement of the progressive lights 122. The backing lights 126 may be configured to illuminate when the vehicle is placed in reverse. That is, the backing lights 126 may function similarly to the reverse light(s) conventionally employed on existing vehicles and illuminate in response to the vehicle being put into the reverse gear. In this regard, the backing lights 126 can be electrically connected to an existing reverse light(s) (or the wires running thereto), such that placing the vehicle in reverse automatically causes the backing lights 126 to illuminate. In some embodiments, the backing lights 126 may be configured to illuminate in a flashing pattern to indicate that the vehicle is in motion in reverse (whether or not the vehicle is in reverse gear). In this way, the backing lights 126 may provide valuable information that is not possible with currently-existing reverse lights, namely by not only indicating that the vehicle is in reverse gear (i.e., by solid, constant illumination of the backing lights 126), but also that the vehicle is actually moving in reverse (i.e., by flashing, intermittent illumination of the backing lights 126). Preferably, the backing lights 126 are visually distinguishable from nearby arrangements of lights, such as the progressive lights 122, the surrounding lights 113 of the central portion 110, and/or the surrounding lights 125 of the first end portion 140. For example, the progressive lights 122 may be of a first color (e.g., red), the surrounding lights 113 of the central portion 110 and the surrounding lights 125 of the first end portion 140 may be of a second, different color (e.g., yellow), and the backing lights 126 may be of a third color (e.g., white) different from the first and second colors.

In addition or alternatively to the backing lights 126, as depicted in as depicted in FIG. 2, a set or arrangement of warning lights 128 may be provided along a border of the progressive lights 122. In the exemplary embodiment of FIG. 2, the backing lights 128 form a lower border of the arrangement of the progressive lights 122 (i.e., opposite the backing lights 126). The warning lights 128 may be configured to illuminate in response to activation of the brakes of the vehicle. That is, the warning lights 128 may function similarly to the third brake light conventionally employed on existing vehicles and illuminate in response to activation of the brakes. In this regard, the warning lights 128 can be electrically connected to an existing third brake light (or the wires running thereto), such that activation of the brakes automatically causes the warning lights 128 to illuminate. In some embodiments, the warning lights 128 may be configured to illuminate in a flashing pattern upon receipt of a signal indicating that a rapid stopping or hard braking condition has occurred (e.g., a rate of deceleration of about 70% or more in about two seconds or less). As will be explained in greater detail herein, the signal for the rapid stopping or hard braking condition can be triggered by, for example, detection of a rapid rate of deceleration of the vehicle. Alternatively, or in addition thereto, the signal for the rapid stopping or hard braking condition can be triggered by engagement of an anti-lock braking system of the vehicle. In this regard, the warning lights 128 can be electrically connected to an existing anti-locking brake system, such that activation of the anti-locking braking system automatically causes the warning lights 128 to illuminate in the flashing pattern. Preferably, the warning lights 128 are visually distinguishable from nearby arrangements of lights, such as the progressive lights 122, the surrounding lights 113 of the central portion 110, and/or the surrounding lights 125 of the first end portion 140. For example, the progressive lights 122 may be of a first color (e.g., red), the surrounding lights 113 of the central portion 110 and the surrounding lights 125 of the first end portion 140 may be of a second, different color (e.g., yellow), and the warning lights 128 may be of a third color (e.g., white) different from the first and second colors. The warning lights 128 can be configured to remain illuminated, constantly, after receipt of the signal indicating the rapid stopping or hard braking condition (e.g., after detection that the vehicle is decelerating at the maximum rate and/or after detection that the anti-lock braking system has been activated). Alternatively, the warning lights 128 may be configured (e.g., through a use of a timer) to illuminate after receipt of the signal indicating the rapid stopping or hard braking condition and until the vehicle comes to a complete stop and then cease illumination after a predetermined period of time (e.g., three seconds).

The safety lighting system 100 may further include a set or arrangement of lights configured for illumination upon receipt of a signal indicating that an emergency condition has occurred or is occurring. For example, as depicted in FIG. 2, one or more emergency lights 160 (e.g., a plurality of LEDs arranged about a cylindrical structure), which may generally be centered on the safety lighting system 100 (e.g., positioned directly above the central portion 110). The emergency lights 160 may be configured to illuminate upon receipt of a signal indicating an emergency condition. By way of non-limiting examples, the signal indicating the emergency condition can be triggered by deployment of the air bags (e.g., with the emergency lights 160 electrically connected to the air bags deployment system), detection of an impact or collision occurring at a speed greater than a predetermined threshold (e.g., 25 mph), detection of a collision in which the accelerometer detects an acceleration over a predetermined threshold (e.g., 10 g), detection of a collision using an impact sensor, and the like. In this regard, the emergency lights 160 could be activated (i.e., illuminated) automatically in response to the aforementioned signal and/or could be activated by manual control, such as via a button on the safety lighting system or a button inside the vehicle that is in communication (e.g., wirelessly or directly wired) to the safety lighting system. In specific embodiments in which the emergency light comprises more than one light (e.g., a plurality of LEDs arranged about a cylindrical structure), the emergency lights 160 may be configured for sequential on-off illumination in which a succeeding light is illuminated when a preceding light goes off, so as to give the visual appearance of a rotational beacon of light.

In certain embodiments, the safety lighting system may be configured such that when the aforementioned signal indicating an emergency situation is received, all of the all of the lights on the safety lighting system may be configured to illuminate at the same time, at a high intensity, and twice as fast as conventional hazard lights, thereby quickly and effectively visually communicating to nearby motorists, riders, or pedestrians that an emergency situation is occurring or has occurred.

The safety lighting system of the present disclosure may also be utilized to display messages indicating a specific condition or situation. For example, a user may be capable of manually choosing from a set of predetermined messages (e.g., “CALL 911,” “MEDICAL,” “EMERGENCY,” “ROADSIDE ASSISTANCE”), which messages can be displayed via the lights arranged on the safety lighting apparatus. The lighted messages may be constant, flash, or “scroll” across the front of the safety lighting system as desired for a particular application. It is also specifically contemplated that one of the predetermined messages can be automatically displayed in response to a signal indicating a specific condition or situation (e.g., a rapid stopping or hard braking condition, that the anti-lock braking system has been activated, that a roadside or medical emergency exists).

Having described the safety lighting system, it will now be helpful to explain how the safety lighting system is powered and controlled. In some embodiments, the safety lighting system may include an internal battery (e.g., one or more self-contained lithium batteries within the emergency lighting system housing), such that the safety lighting system is self-powered. In such embodiments, the safety lighting system may further include one or more solar panels (e.g., mounted to the top surface of the safety lighting system) electrically connected to the internal battery for delivering power to the internal battery. In other embodiments, the internal battery can be electrically connected to the vehicle's existing battery and charged thereby. The internal battery may be capable of powering the safety lighting system for about three hours, including up to for about eight hours, thereby providing sufficient time for the safety lighting system to alert other motorists, riders, or pedestrians of the vehicle's specific condition.

The safety lighting system may further include other components that increase the safety of the vehicle's user in addition to other motorists, riders, or pedestrians. For example, the safety lighting system can include a variety of outputs (e.g., USB, mini-USB, micro-USB, and the like) along a side face of the housing. In this way, even when the vehicle's existing battery may non-operational, power may be supplied to the outputs of the safety lighting system (e.g., from the internal battery thereof) to power and/or charge a variety of electronic devices (e.g., a cellular telephone) that may aid in ensuring further safety for and necessary attention to the vehicle and/or its occupant(s). In addition, it is contemplated that audio and/or visual monitors could be included integrally or along with the safety lighting system for monitoring surrounding road conditions. In such embodiments, the safety lighting system can include its only storage means for storing captured audio and/or video footage. Further yet, the safety lighting system could include a feature to send a signal (e.g., automatically or by manual control) to surrounding motorists, riders, or pedestrians (e.g., within about 100 feet of the safety lighting system) that have a corresponding receiver, the signal indicating that the vehicle equipped with the safety lighting system is in a certain condition or situation (e.g., a rapid stopping or hard braking condition, that the anti-lock braking system has been activated, that a roadside or medical emergency exists). In this regard, the lighting system could be configured to automatically send such a signal to emergency vehicles in the vicinity of the light bar system.

The programming and logic that receives condition signals and controls operation of the various lights is stored on a controller (e.g., a microprocessor) that is preferably housed within the safety lighting system. As used herein, the term “stored” is intended to cover software programming, hard-wiring (e.g., via solid state relay-type devices, switches), wireless connectivity, and integrated circuitry. In this regard, the “controller” referred to herein may include, for example, an integrated circuit of a microprocessor and a graphic user interface. The controller is connected to the various lights (e.g., via a switch unit) and programmed to illuminate the lights in accordance with the present disclosure. The controller is further configured to receive various signals indicating a variety of conditions or situations as described herein (e.g., a rapid stopping or hard braking condition, that the anti-lock braking system has been activated, that a roadside or medical emergency exists), to interpret such signals, and to facilitate dynamic display of the various condition information via the lights, in accordance with the present disclosure. For example, the controller may generally include a signal receiving/processing/interpreting component, a vehicle rate of deceleration determination component, a dynamic display determination component, and other like components.

The signal receiving/processing/interpreting component can, for example, be configured to receive, interpret, and/or process a signal received from one or more of a variety of sources, such as from a triple-axis accelerometer built into the safety lighting system, from a connection via the diagnostic port (e.g., through a wired connection or wireless dongle), from radar means directed in the direction of the surface over which the vehicle is passing, from GPS or A-GPS or similar positional tracking, from a transducer attached to the vehicles speedometer cable, and the like.

The vehicle rate of deceleration determination component may be configured to determine the vehicle's rate of deceleration based on the signal received by the signal receiving/processing/interpreting component. In particular embodiments, a function may be configured into the vehicle rate of deceleration determination component to determine the vehicle's rate of deceleration. In this regard, it is to be understood that the vehicle's rate of deceleration may be derived by any suitable means. Further, it is to be understood that the rate of deceleration of the vehicle determined by the vehicle rate of deceleration determination component need not necessarily have an absolute value; rather, the determined rate of deceleration may be a ratio or percentage value indicative of a degree of deceleration relative to the vehicle's initial acceleration at a time immediately before deceleration begins. For example, the vehicle rate of deceleration determination component may determine an about 10% reduction in acceleration (e.g., corresponding to a first or lowest level of reduction in acceleration).

The dynamic display determination component may be configured to control illumination of the lights of the safety lighting system in accordance with the present disclosure. In this regard, the dynamic display determination component may determine various parameters for the lights, such as the illumination pattern (e.g., constant, flashing), the illumination area, the illumination frequency, the illumination color, and the illumination intensity. The dynamic display determination component may make such determination based on the determined rate of deceleration and other signals received by the signal receiving component (e.g., activation of the brakes, activation of a turn signal, activation of the anti-lock braking system, movement of the vehicle in reverse, engagement of the vehicle in the reverse gear). In this way, the dynamic display determination component may determine such illumination parameters based upon predetermined and/or preprogrammed associations between the received information and signals and the specific illumination parameter(s), as explained in greater detail herein. In this regard, such associations may generally be predetermined and preprogrammed into memory storage accessible and retrievable by the controller. Exemplary associations between various signals and information, namely rate of deceleration of the vehicle, and various illumination parameters are provided herein.

As will be appreciated by those skilled in the art, the controller may be of any suitable type, such as a generic controller configured to execute machine-readable instructions, and/or specialized controller such as Electronic/engine Control Module (ECM), Powertrain Control Module (PCM), Transmission Control Module (TCM), Brake Control Module (BCM or EBCM), Central Control Module (CCM), Central Timing Module (CTM), General Electronic Module (GEM), speech recognition IC, and/or any other specialized controllers.

As previously described, some embodiments of the safety lighting system use a built-in accelerometer connected to the controller. In particular, the accelerometer may send a signal to the controller representing the instantaneous deceleration of the vehicle to accurately evaluate the magnitude of the vehicle declaration. The accelerometer is preferably a triple-axis accelerometer (e.g., of the piezoelectric type) having a range of from about 0.02 g to about 16.0 g and producing a proportional output signal connected to and received by the controller.

In addition (or alternatively) to using an accelerometer, the controller may be electrically connected to the vehicle's diagnostic port (e.g., via a dongle wireless communicating between the vehicle's diagnostic port and the safety lighting system's controller). When used in combination with one another, vehicle speed information received via the diagnostic port can supplement the accelerometer, especially where external factors such as the vehicle's weight and brake condition and the condition of the road may make it such that the accelerometer is incapable of accurately representing the vehicle's actual rate of deceleration. In this regard, the safety lighting system may, in certain embodiments, be provided with a dongle that is preferably wirelessly (though could be hard-wired) connected to the controller of the safety lighting system. The wireless connection could be, by way of non-limiting examples, of the narrowband radio frequency type, the ultra-wide band type, or the spread-spectrum type (e.g., Bluetooth, 802.11a/b/g).

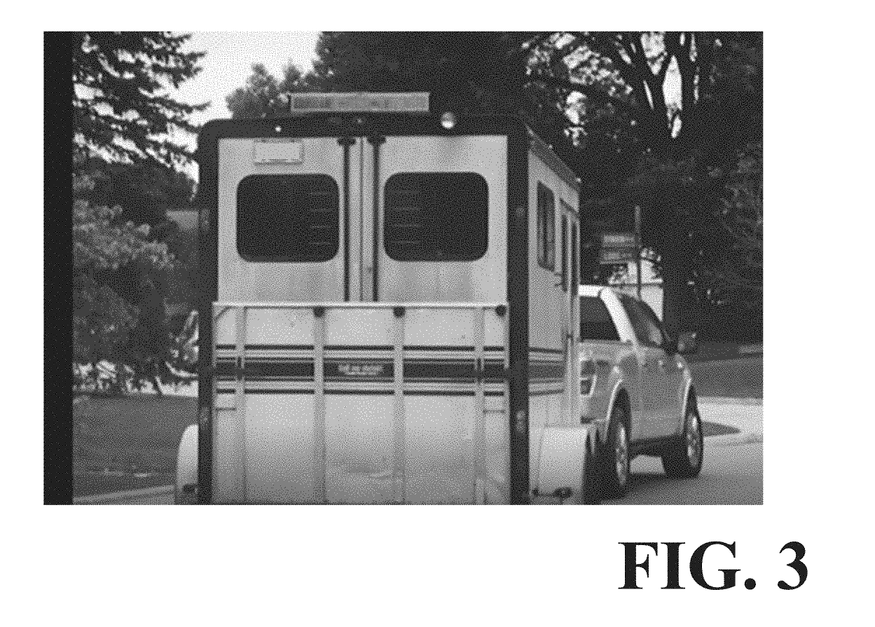

The specific illumination states employed in one embodiment of the present disclosure will be hereinafter described with reference to FIGS. 3-12.

In FIG. 3, the safety lighting system is shown in a normal “running” illumination state with only the lights bordering the safety lighting system at its outermost edge being illuminated in red. That is, in FIG. 3, the safety lighting system is illuminated similar to conventional running lights, and no braking or slowing condition is occurring. In this regard, surrounding motorists, riders, or pedestrians are immediately capable of recognizing that, in this illumination state, the vehicle is either accelerating or the acceleration of the vehicle has leveled off for a predetermined threshold (e.g., three seconds), but that the vehicle is not decelerating (i.e., via either activation of the brakes, release of the gas pedal, or some other slowing of the vehicle).

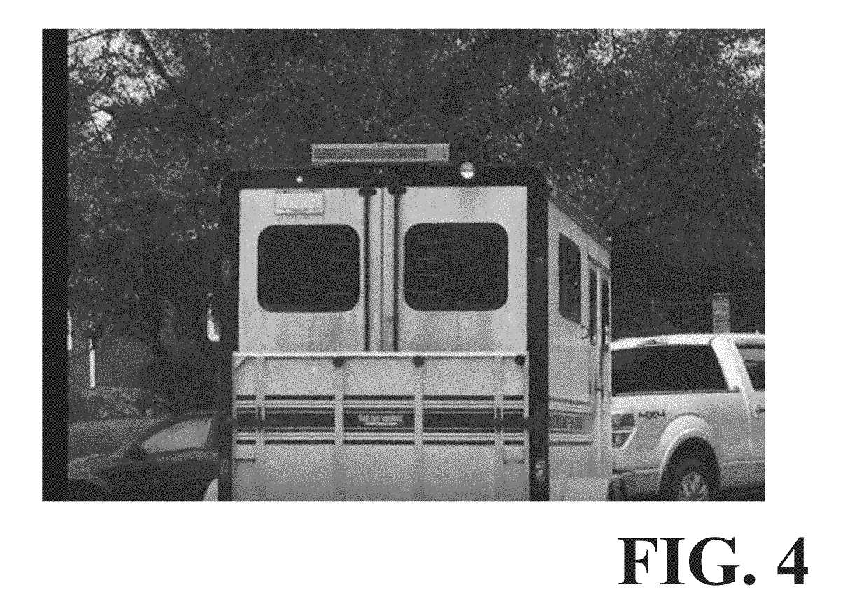

Turning to FIG. 4, the safety lighting system is shown with the border lights illuminated in addition to the interior lights at the distal end of the first end portion illuminated in a flashing pattern (not shown) in red to indicate to surrounding motorists, riders, and pedestrians that the vehicle is turning right.

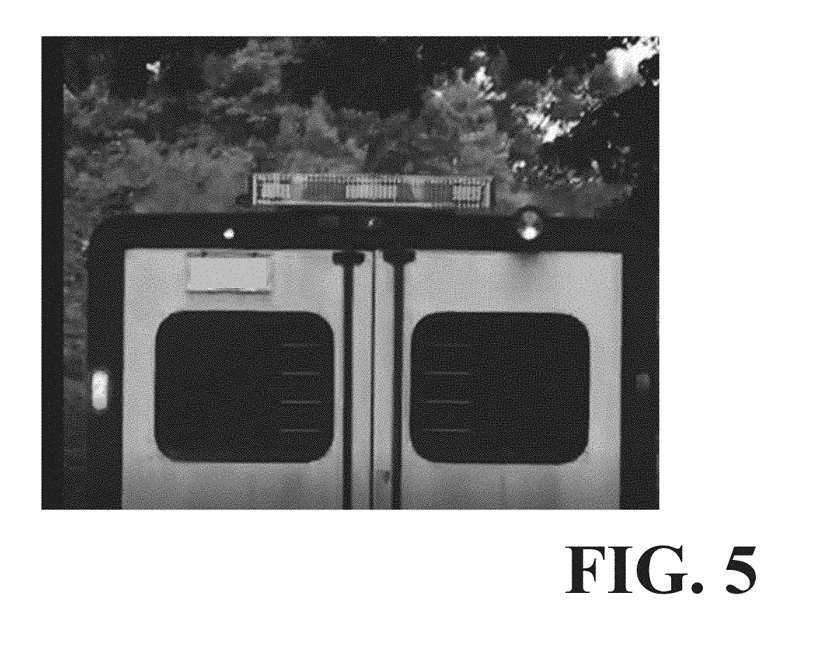

With respect now to FIG. 5, the safety lighting system is shown in an initial braking condition (i.e., immediately after the brakes have been activated). As a result, the interior lights in the central portion and the interior lights at the distal ends of each of the first and second side portions are all illuminated in red to indicate to surrounding motorists, riders, and pedestrians that the vehicle is braking.

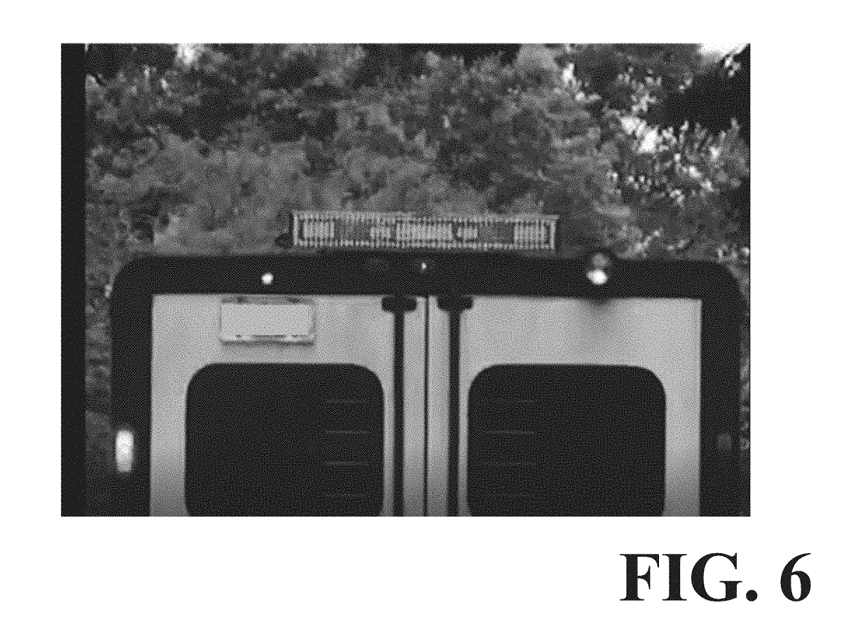

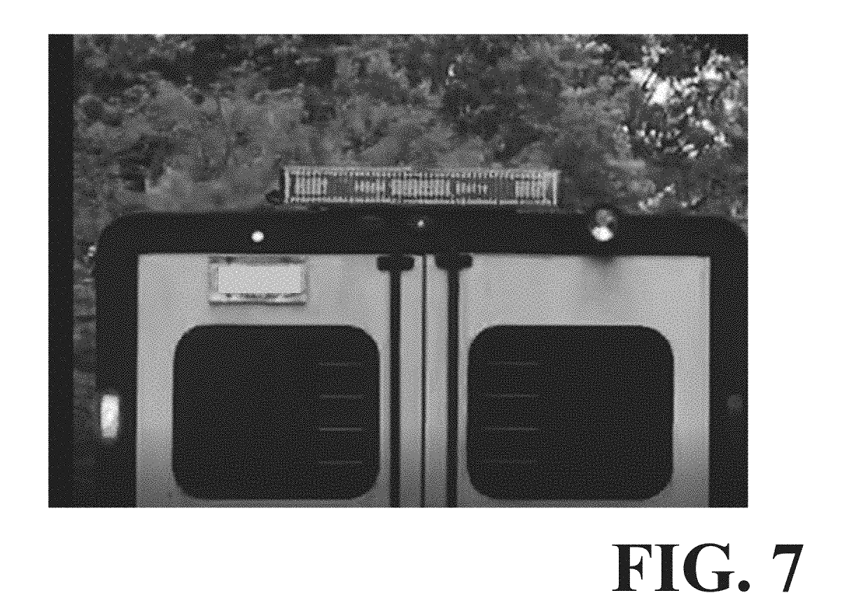

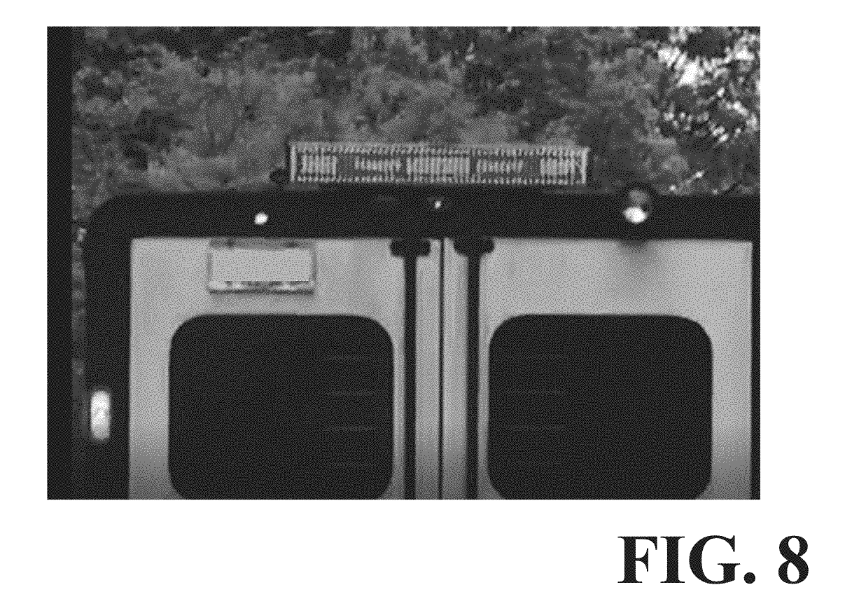

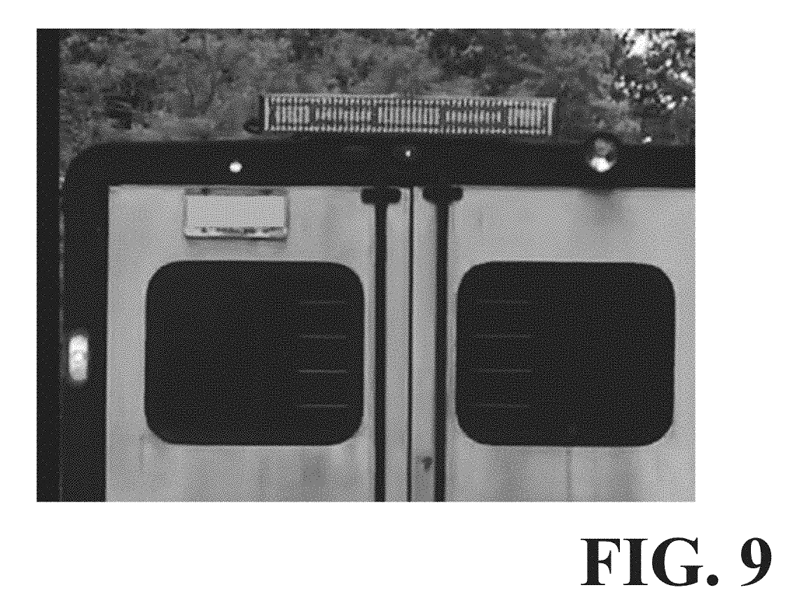

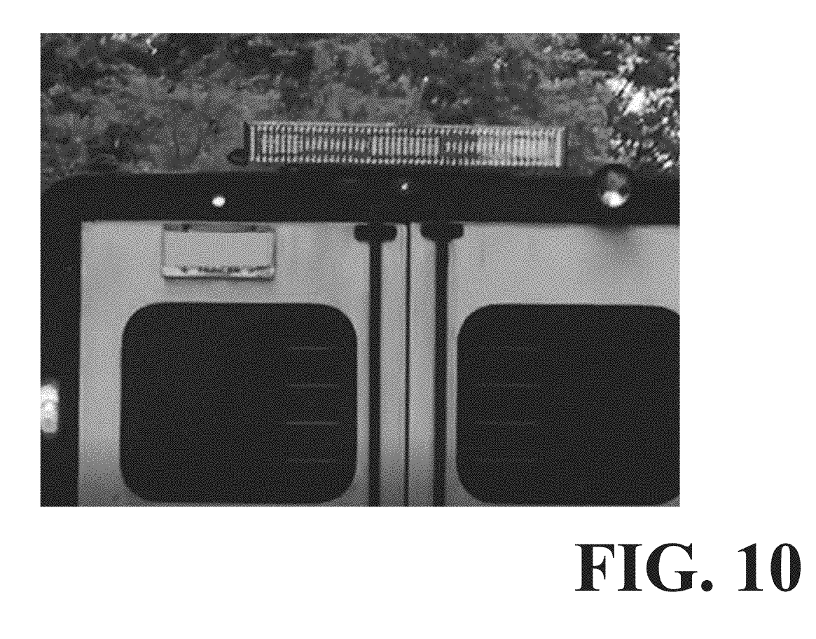

In FIGS. 6-9, the safety lighting system is in a gradual braking condition (i.e., the brakes remain activated and the vehicle is gradually decelerating over time). Because the brakes are still being activated, the interior lights in the central portion and the interior lights at the distal ends of each of the first and second side portions all remain illuminated in red to indicate to surrounding motorists, riders, and pedestrians that the vehicle is still braking. In addition, the progressive lights in each of the first and second side portions illuminate sequentially (as seen from FIG. 6 to FIG. 9) outwardly away from the central portion toward respective ones of the distal ends of each of the first and second side portions as the rate of deceleration of the vehicle increases. For example, in FIG. 6, only the first section of the progressive lights on each of the first and second side portions is illuminated, thereby indicating to surrounding motorists, riders, and pedestrians that the vehicle has slowed (e.g., about 10%) from its initial acceleration at a time immediately before deceleration began. In FIG. 7, on the other hand, both of the first two sections of the progressive lights on each of the first and second side portions are illuminated, thereby indicating to surrounding motorists, riders, and pedestrians that the vehicle has slowed even more relative to FIG. 6 (e.g., about 30% from its initial acceleration at a time immediately before deceleration began). Next, in FIG. 8, each of the first three sections of the progressive lights on each of the first and second side portions are illuminated, thereby indicating to surrounding motorists, riders, and pedestrians that the vehicle has slowed even more relative to FIG. 7 (e.g., about 50% from its initial acceleration at a time immediately before deceleration began). Continuing on, in FIG. 9, each of the first four sections of the progressive lights on each of the first and second side portions are illuminated, thereby indicating to surrounding motorists, riders, and pedestrians that the vehicle has slowed even more relative to FIG. 8 (e.g., about 70% from its initial acceleration at a time immediately before deceleration began). Finally, in FIG. 10, all of the sections of the progressive lights on each of the first and second side portions are illuminated, thereby indicating to surrounding motorists, riders, and pedestrians that the vehicle has slowed even more relative to FIG. 9 (e.g., about 90% from its initial acceleration at a time immediately before deceleration began).

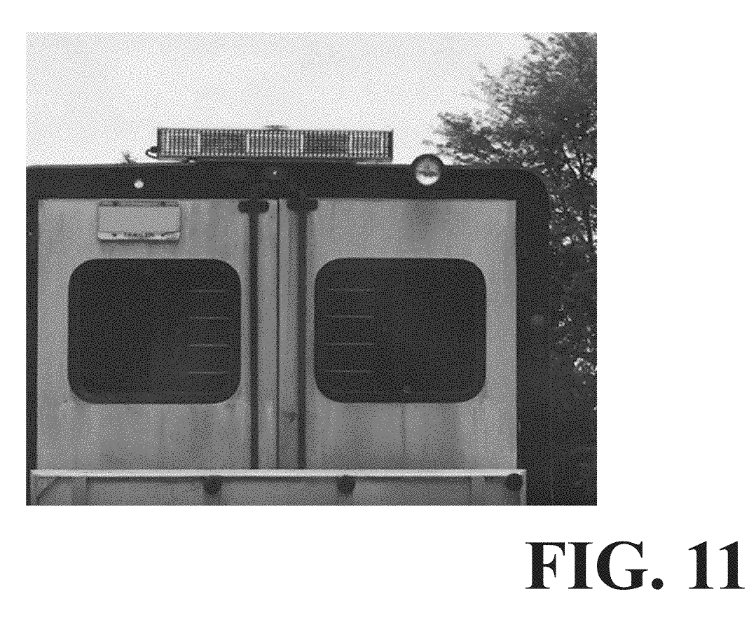

Turning to FIG. 11, the safety lighting system is shown in a completely stopped condition (i.e., zero measured acceleration) as the brakes remain activated. Because the brakes are still being activated, the interior lights in the central portion and the interior lights at the distal ends of each of the first and second side portions all remain illuminated in red to indicate to surrounding motorists, riders, and pedestrians that the vehicle is still braking. In addition, the lights surrounding each of the arrangements of interior lights are also illuminated in yellow to indicate to surrounding motorists, riders, and pedestrians that the vehicle is at a complete stop.

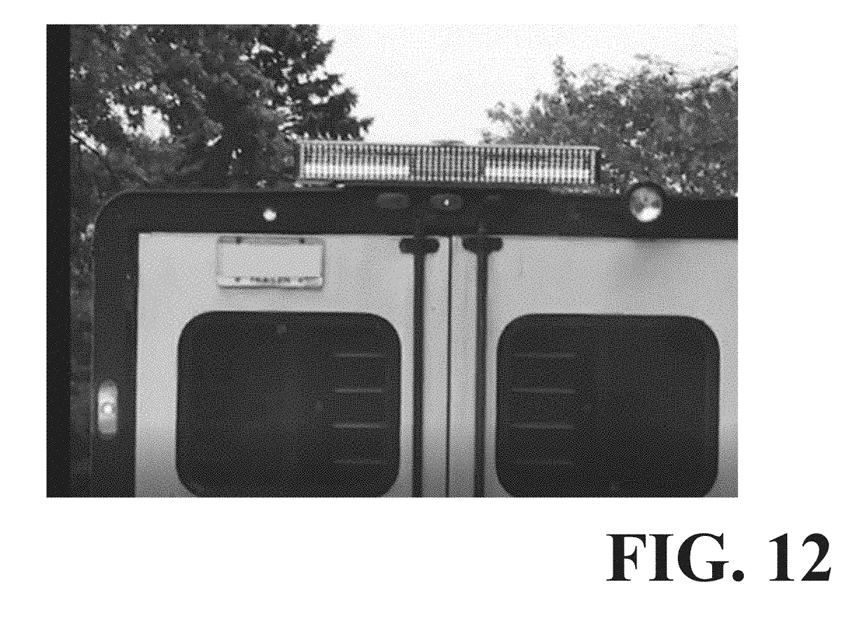

With respect now to FIG. 12, the safety lighting system is shown in a hard braking condition. As a result of the hard braking condition (e.g., a rate of deceleration of about 70% or more in about two seconds or less, activation of the vehicle's anti-lock braking system), the warning lights forming a lower border of each of the first and second end portions is illuminated in white, thereby indicating to surrounding motorists, riders, and pedestrians that the vehicle is rapidly stopping and/or braking.

In addition to the aforementioned illumination states, the safety lighting system may be further configured for other illumination states associated with specific situations or conditions, such as:
a. a standard hazard illumination state in which: all of the yellow surrounding lights illuminate simultaneously in a flashing pattern at the normal hazard flashing rate;
b. a police emergency illumination state in which: all of the yellow surrounding lights illuminate simultaneously in a flashing pattern, the white warning lights illuminate in a flashing pattern, the red interior lights illuminate in a flashing pattern spelling out the phrase “CALL 911,” and the red progressive lights illuminate in a flashing pattern spelling out the phrases “POLICE” and “EMERGENCY,” with all of the lights flashing at a rate that is at least twice the normal hazard flashing rate;
c. a medical emergency illumination state in which: all of the yellow surrounding lights illuminate simultaneously in a flashing pattern, the white reverse lights illuminate in a flashing pattern, the red interior lights illuminate in a flashing pattern spelling out the phrase “CALL 911,” and the red progressive lights illuminate in a flashing pattern spelling out the phrases “MEDICAL” and “EMERGENCY,” with all of the lights flashing at a rate that is at least four times the normal hazard flashing rate;
d. a medical/police emergency illumination state in which: all of the yellow surrounding lights illuminate simultaneously in a flashing pattern, the white reverse lights illuminate in a flashing pattern, the white warning lights illuminate in a flashing pattern, the red interior lights illuminate in a flashing pattern spelling out the phrase “CALL 911,” and the red progressive lights illuminate in a flashing pattern spelling out the phrases “MEDICAL/POLICE” and “EMERGENCY,” with all of the lights flashing at a rate that is at least six times the normal hazard flashing rate;
e. a life-threatening emergency illumination state in which: all of the yellow surrounding lights illuminate simultaneously in a flashing pattern, the white reverse lights illuminate in a flashing pattern, the white warning lights illuminate in a flashing pattern, the red interior lights illuminate in a flashing pattern spelling out the phrase “CALL 911,” the red progressive lights illuminate in a flashing pattern spelling out the phrases “MEDICAL/POLICE” and “EMERGENCY,” and the emergency light illuminates, with all of the lights flashing at a rate that is at least six times the normal hazard flashing rate; and
f. a collision illumination state in which: all of the lights in the safety lighting system will illuminate in a flashing pattern and in their corresponding colors at a rate that is at least four times the normal hazard flashing rate.

The safety lighting system of the present disclosure can be quickly and efficiently produced using a relatively small number of relatively inexpensive components (e.g., a housing constructed of restaurant-grade plastics) that, as described herein, provide visual indications to surrounding motorists, riders, or pedestrians as to whether and how soon the vehicle is likely to stop and/or other slowing, braking, or emergency conditions of the vehicle, thereby affording the surrounding motorists, riders, or pedestrians valuable time in which to process and react to the visual indications and take any corrective or helpful actions as may be possible or necessary. In addition, because the safety lighting system of the present disclosure may be self-powered, the safety lighting system may function as a complement to or failsafe for the existing rear lighting system (e.g., including brake, reverse, and turn signal lights) on a vehicle.

In some embodiments, all of the lights on the safety lighting system may be configured to illuminate at the same time and in the same color (e.g., white) at a high intensity, thereby allowing the safety lighting system to be used as a utility light (e.g., for illuminating an unlit area or object).

It is specifically contemplated that in the case of relatively smaller vehicles (e.g., motorcycles), the safety lighting system of the present disclosure could be worn by the vehicle's occupant, such as part of a garment (e.g., a reflective vest) worn by the occupant.

As will now be fully appreciated, the safety lighting system of the present disclosure provides the ability for various distinct patterns and arrangements of lights that enable surrounding motorists and riders a quick and effective indication of the slowing, braking, and/or conditions stopping (or stopped) conditions of the vehicle to which the safety lighting system is equipped. For example, a surrounding motorist, rider, or pedestrian will immediately recognize that the vehicle is at a complete stop when the yellow surrounding lights are illuminated (e.g., in yellow). Similarly, the surrounding motorist, rider, or pedestrian will immediately recognize that the vehicle is slowing or coming to a gradual stop when the progressive lights are slowly sequentially illuminated (e.g., in red). Conversely, the surrounding motorist, rider, or pedestrian will immediately recognize that the vehicle is rapidly braking coming to a quick stop when the progressive lights are quickly sequentially illuminated (e.g., in red) and/or the warning lights are illuminated (e.g., in white). In short, the safety lighting system of the present disclosure provides surrounding motorists, riders, or pedestrians with valuable information about the slowing and/or braking conditions of the vehicle quickly and effectively, which information is not currently available from conventional, binary (one-dimensional) brake light systems currently in use (i.e., “normal” and “hard” braking conditions are visually indistinguishable in current brake light systems).

Although certain exemplary devices are used in the embodiments described herein for measuring, monitoring, and/or detecting the rate of deceleration, it is to be understood that any other appropriate means may be utilized to measure, monitor, and/or detect the rate of deceleration. As will be appreciated by those skilled in the art, possible means include a triple-axis accelerometer built into the safety lighting system, connection via the diagnostic port (e.g., through a wired connection or wireless dongle), radar means directed in the direction of the surface over which the vehicle is passing, by GPS or A-GPS or similar positional tracking, a transducer attached to the vehicles speedometer cable, and the like.

Although a controller is the preferred device for receiving and processing the vehicle's speed and/or acceleration information because it is programmable and upgradable, it is to be understood that any other appropriate means may be utilized to receive and process the vehicle's speed and/or acceleration information.

Referring back to the arrangement of the lights of the safety lighting system, it is to be understood that although a generally linear display arrangement comprised of individual light emitting diodes is preferred, any other appropriate arrangement of lights may be utilized so long as the lights are configured for sequential illumination in response to activation of the brakes and proportional to the rate of deceleration of the vehicle.

The safety light system of the present disclosure provides several advantages over conventional brake lights. For example, the safety light system of the present disclosure may be used to replace the third brake light traditionally and may provide significantly more information to other motorists and riders, such as indications of the precise braking conditions, which is not possible with conventional, binary (one-dimensional) braking systems. As a result, both the vehicle's user and other motorists and riders benefit from increased safety due to the ability for the other motorists and riders to quickly and correctly interpret the visual indication of the braking condition and appropriately activate their own brakes, as necessary. In short, through use of the safety lighting system of the present disclosure, other motorists, riders, or pedestrians will be afforded additional to assess and react to rapid deceleration of the vehicle so as to take any necessary corrective action in order to avoid a collision.

The above specification, examples and data provide a description of the structure and use of exemplary embodiments of the invention as defined in the claims. Although various embodiments of the claimed invention have been described above with a certain degree of particularity, or with reference to one or more individual embodiments, those skilled in the art could make numerous alterations to the disclosed embodiments without departing from the spirit or scope of the claimed invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A safety lighting system, comprising:
a controller configured to receive at least one of speed and acceleration information of an associated vehicle including brakes;
a central portion including a first plurality of light emitting diodes configured for illumination in response to activation of the brakes of the associated vehicle; and
first and second side portions positioned on opposite sides of the central portion, each of the first and second side portions including a second plurality of light emitting diodes configured for sequential illumination from a proximate end to a distal end thereof in response to and proportional to a rate of deceleration of the associated vehicle.

2. The safety lighting system of claim 1, wherein the second plurality of light emitting diodes are arranged in at least five discrete sections, each of the five discrete sections associated with a discrete range of the rate of deceleration of the associated vehicle such that additional ones of the discrete sections are sequentially illuminated as the rate of deceleration of the associated vehicle increases.

3. The safety lighting system of claim 1, further comprising a first end portion positioned at the distal end of the first side portion and a second end portion positioned at the distal end of the second side portion, each of the first and second end portions including a third plurality of light emitting diodes located at the distal end thereof and are configured for flashing illumination in association with a turn signal of the associated vehicle.

4. The safety lighting system of claim 3, wherein each of the first and second side portions further includes:
a fourth plurality of light emitting diodes surrounding the first plurality of light emitting diodes, the fourth plurality of light emitting diodes configured for illumination in response to a signal indicating that the associated vehicle is stopped; and
a fifth plurality of light emitting diodes surrounding the third plurality of light emitting diodes, the fifth plurality of light emitting diodes configured for illumination in response to a signal indicating that the associated vehicle is stopped.

5. The safety lighting system of claim 4, wherein the first, second, and third pluralities of light emitting diodes are configured for illumination in a first color and the fourth and fifth pluralities of light emitting diodes are configured for illumination in a second color different from the first color.

6. The safety lighting system of claim 4, wherein each of the first and second side portions further includes:
a sixth plurality of light emitting diodes bordering the second plurality of light emitting diodes, the sixth plurality of light emitting diodes configured for illumination in association with a reverse light of the associated vehicle.

7. The safety lighting system of claim 6, wherein the first, second, and third pluralities of light emitting diodes are configured for illumination in a first color, the fourth and fifth pluralities of light emitting diodes are configured for illumination in a second color different from the first color, and the sixth plurality of light emitting diodes are configured for illumination in a third color different from the first and second colors.

8. The safety lighting system of claim 6, wherein the sixth plurality of light emitting diodes is configured for flashing illumination in response to a signal indicating that the associated vehicle is in motion in reverse.

9. The safety lighting system of claim 6, wherein each of the first and second side portions further includes:
a seventh plurality of light emitting diodes bordering the second plurality of light emitting diodes, the seventh plurality of light emitting diodes configured for illumination in response to activation of the brakes of the associated vehicle.

10. The safety lighting system of claim 9, wherein the seventh plurality of light emitting diodes is configured for flashing illumination in response to a signal indicating at least one of a rapid stopping condition and a hard braking condition associated with rapid deceleration of the associated vehicle.

11. The safety lighting system of claim 9, wherein the first, second, and third pluralities of light emitting diodes are configured for illumination in a first color, the fourth and fifth pluralities of light emitting diodes are configured for illumination in a second color different from the first color, and the sixth and seventh pluralities of light emitting diodes are configured for illumination in a third color different from the first and second colors.

12. The safety lighting system of claim 9, further comprising an accelerometer configured to detect acceleration of the associated vehicle.

13. The safety lighting system of claim 12, wherein at least one of the first, second, and third pluralities of light emitting diodes are configured for illumination of an emergency message in response to the accelerometer detecting a rate of deceleration greater than a predetermined threshold.

14. The safety lighting system of claim 1, further comprising an emergency light positioned above the central portion, the emergency light configured for illumination in response to a signal indicating an emergency condition.

15. The safety lighting system of claim 1, further comprising an internal battery configured to power the safety lighting system.

16. The safety lighting system of claim 15, further comprising at least one solar panel electrically connected to the internal battery.

17. The safety lighting system of claim 1, further comprising a dongle configured for electrical connection to the associated vehicle and configured to wirelessly transmit the at least one of speed and acceleration information of the associated vehicle to the safety lighting system.

18. A vehicle comprising the safety lighting system of claim 1.

19. A safety lighting system, comprising:
a controller configured to receive at least one of speed and acceleration information of an associated vehicle including brakes; and
a plurality of light emitting diodes arranged so as to define each of a central portion and first and second side portions positioned on opposite sides of the central portion;
wherein the plurality of light emitting diodes are selectively illuminable in accordance with at least the following illumination states:
(a) an illumination state in which the light emitting diodes arranged in the central portion and the first and second end portions are configured for illumination in response to activation of the brakes of the associated vehicle; and
(b) an illumination state in which the light emitting diodes arranged in each of the first and second side portions are configured for illumination in response to and proportional to a rate of deceleration of the associated vehicle.

20. A vehicle comprising the safety lighting system of claim 19.
